(19) United States
(12) Patent Application Publication
(10) Pub. No.: US 2024/0029059 A1
(43) Pub. Date: Jan. 25, 2024

(54) MESH NETWORK COMMUNICATIONS UTILIZING TOKENIZATION CONNECTIONS

(71) Applicant: Quixotic Holdings, LLC, Lakeland, FL (US)

(72) Inventors: Charles Robert Gorectke, Lakeland, FL (US); Ryan Scott Luther, Lakeland, FL (US); Tarek Abdel-Halim, Chicago, IL (US)

(21) Appl. No.: 18/221,317

(22) Filed: Jul. 12, 2023

Related U.S. Application Data
(60) Provisional application No. 63/390,580, filed on Jul. 19, 2022.

(51) Int. Cl. G06Q 20/38; H04L 67/104

(52) U.S. Cl. CPC G06Q 20/381; H04L 67/104

(57) ABSTRACT

Systems and methods described herein are directed to utilizing a multiple network credits to enable computing devices to access and utilize a mesh network. A request is received to access the network. The request is sent to a government currency-to-token exchange to exchange government currency from the user into tokens for the user. The tokens are then exchanged into network credits, which are assigned to the user. A network-access request associated with the user is then received. A portion of the network credits are re-assigned from the user to other users based on the network-access request. The user is then enabled to access to the network for the network-access request in response to the re-assignment of the portion of the network credits.

### BACKGROUND

### Technical Field

The present disclosure relates generally to network management and, more particularly, to utilizing a multiple token and network credit exchanges to enable tokenized routing, processing, or storage within a mesh network.

### Description of the Related Art

Mesh networks enable computing devices, or nodes, to communicate with one another, while allowing the computing devices to enter or leave the network without disrupting the communications of other computing devices in the network. Whether a computing device enters or leaves a network is generally dependent on many factors, some of which may include the current location of the computing device relative to other computing devices, computing resource availability of the computing device, hardware constraints of the computing device, etc. In some situations, users can also determine whether, or how much, their computing device is to participate in the network. Many mesh networks, however, find it difficult to manage the type or amount of network utilization being used by individual computing devices within the network. Moreover, mesh networks generally lack the capability of incentivizing users to have their computing device enter or leave the network. It is with respect to these and other considerations that the following disclosure addresses.

### BRIEF SUMMARY

Briefly stated, embodiments described herein are directed to utilizing a multiple token and network credit exchanges to enable tokenized routing, processing, or storage within a mesh network. Briefly, government currency is exchanged into tokens, such as cryptocurrency, and the tokens are exchanged into network credits for particular users. The user's network credits are deducted from the user's account as the participant computing device of that user accesses or utilizes the network. Those network credits are then re-assigned to the users of the participant computing devices in the mesh network that enabled that access by the user. In this way, network credits can be purchased and used to access the network, and network credits can be earned by allowing your device to enable another's access to the network.

A request for a user to access a network is received. The request is sent to a government currency-to-token exchange to exchange government currency from the user into tokens for the user. Confirmation of a successful exchange into the tokens for the user is recited. An internal treasury is used to exchange the tokens into network credits, which are then assigned to the user. A network-access request associated with the user is then received from a participant computing device of the user. A portion of the network credits for the user are reassigned to other users based on the network-access request. Access to the network for the network-access request is then enabled in response to the re-assignment of the portion of the network credits for the user.

Embodiments described herein provide improved methods and systems for accessing and using a mesh network. The exchange and use of network credits, as described herein, allows for the efficient use to computing resources, while incentivizing the upgrading of other computing resources.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for utilizing a tokenized mesh network in accordance with embodiments described herein;

FIG. 2 illustrates a block diagram of components to facilitate the exchange of government currency to networking credits to enable a tokenized mesh network in accordance with embodiments described herein;

FIG. 3 illustrates a logical flow diagram showing one embodiment of a process for employing a tokenized mesh network in accordance with embodiments described herein;

FIG. 4 illustrates a logical flow diagram showing one embodiment of a process for exchanging government currency into network credits in accordance with embodiments described herein;

FIGS. 5 and 6 illustrate logical flow diagrams showing embodiments of processes for utilizing network credits to route messages, process data, or store data in accordance with embodiments described herein;

FIG. 7 illustrates a logical flow diagram showing one embodiment of a process for exchanging network credits into government currency in accordance with embodiments described herein; and

FIG. 8 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

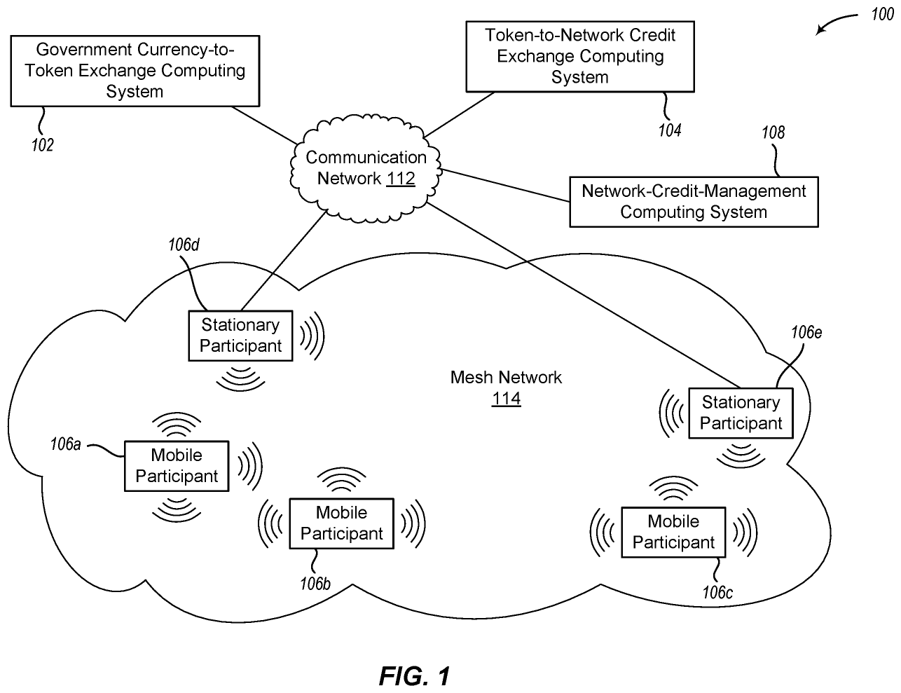

FIG. 1 illustrates a context diagram of an environment 100 for utilizing a tokenized mesh network 114 in accordance with embodiments described herein. Environment 100 includes a network-credit-management computing system 108, a government currency-to-token exchange computing system 102, a token-to-network credit exchange computing system 104, a communication network 112, and a plurality of participant computing devices 106a-106e. Collectively, the participant computing devices 106a-106e, and the communications therebetween, make up the mesh network 114. Although described as a mesh network, other network types or structures may also be utilized.

As referred to herein, a “participant” or “participant computing device” is a computing device that can communicate specific, predetermined types of information and data to other participant computing devices through the mesh network 114. The participant computing devices 106 can include mobile participant computing devices, such as participant computing devices 106a-106c, or stationary participant computing devices, such as participant computing devices 106d-106e. Examples of different types of participant computing devices are discussed in more detail below.

The communications between participant computing devices 106 is generally via line-of-sight communications, but other wired communications may also be utilized (e.g., from one stationary participant computing device to another stationary participant computing device). As referred to herein, “line-of-sight communication” refers to wireless transmission of information from a participant to another participant without other retransmission devices. Accordingly, line-of-sight is the maximum range one participant can communicate wirelessly with another participant without significant data loss. Examples of wireless transmissions used in line-of-sight communications include Bluetooth, Wi-Fi, ADSB, TCAS, or other protocols now known or developed in the future. In some embodiments, all communications between participants utilize a common protocol.

As described in more detail herein, users of the participant computing devices 106 may utilize the network-credit-management computing system 108 to exchange government currency into network credits to access or utilize the mesh network 114. For example, users of the participant computing devices 106 may exchange government currency into routing credits to route or transmit data or messages throughout the mesh network 114. The users of the participant computing devices 106 may exchange government currency into processing credits to have other participant computing devices 106 process the data. The users of the participant computing devices 106 may also exchange government currency into storage credits to have other participant computing devices 106 store the data. As used herein, “network credit” refers collectively to routing credits, processing credits, and storage credits that are to be used to access or utilize the mesh network 114. Although embodiments described herein discuss the use of routing credits, processing credits, and storage credits, embodiments are not so limited. Rather, a plurality of different credits may be utilized by the participant computing devices 106 to perform different actions within the mesh network 114. Moreover, networks credits may be referred to as tokens, vouchers, notes, or some other name.

To obtain network credits, users may send a request to the network-credit-management computing system 108, via the participant computing devices 106a-106e or other computing devices that are not part of the mesh network 114. The network-credit-management computing system 108 coordinates with the government currency-to-token exchange computing system 102 to first exchange government currency into tokens and then coordinates with the token-to-network credit exchange computing system 104 to exchange the tokens into the appropriate networking credits.

The network-credit-management computing system 108 manages the network credits and how they are distributed as participant computing devices 106 access and utilize the mesh network 114. For example, if participant computing device 106a wants to transmit a message or data to participant computing device 106c, then the network-credit-management computing system 108 determines a route from the source computing device (i.e., participant computing device 106a) to the destination computing device (i.e., participant computing device 106c). In some embodiments, the participant computing device 106a determines the route, or at least a next computing device in which to transmit data, and notifies the network-credit-management computing system 108 of the determined route.

In this illustrative example, the route may be from mobile participant computing device 106a to stationary participant computing device 106d to stationary participant computing device 106e to mobile participant computing device 106c. The network-credit-management computing system 108 then determines a number of networking credits (e.g., routing credits) needed to transmit the data from the mobile participant computing device 106a to the mobile participant computing device 106c along the determined route. Those network credits are then deducted from the account of the user associated with the mobile participant computing device 106a and re-distributed to the users of the stationary participant computing device 106d and the stationary participant computing device 106e, and possibly the mobile participant computing device 106c.

If mobile participant computing device 106c is to store the data that it received from the mobile participant computing device 106a, then the network-credit-management computing system 108 deducts an additional number of network credits (e.g., storage credits) necessary for the storage of the data from the account of the user associated with the mobile participant computing device 106a and re-distributes those credits to the user of the mobile participant computing device 104c. Similarly, if mobile participant computing device 106c is to process the data that it received from the mobile participant computing device 106a, then the network-credit-management computing system 108 deducts a further number of network credits (e.g., processing credits) necessary for the processing of the data from the account of the user associated with the mobile participant computing device 106a and re-distributes those credits to the user of the mobile participant computing device 104c.

In some embodiments, a source participant computing device 106 may communicate with a destination device that is not part of the mesh network 114. As such, network credits are deducted from the user for the portion of the communications that utilize the mesh network 114, and those credits are re-allocated to the participant computing devices of the mesh network that participated in those communications, as described herein.

The government currency-to-token exchange computing system 102 is a publicly available cryptocurrency exchange service that exchanges government currency (e.g., U.S. dollars) into cryptocurrency (i.e., tokens), such as Bitcoin, Ethereum, Avalanche, etc. In some instances, the tokens can be consider intermediate tokens between the user's currency and the network credits. A token could also be considered a voucher, flag, indexed marker, chit, credit, marker, cryptocurrency, digital currency, note, security, or have some other name. A token is something that can be stored and be traded for something else, and it usually has a value or specific meaning associated with each token. The government currency-to-token exchange computing system 102 may also allow for the exchange from one cryptocurrency to the tokens (e.g., another cryptocurrency).

The token-to-network credit exchange computing system 104 is a private or internal treasure that can exchange the tokens into network credits. The token-to-network credit exchange computing system 104 maintains exchange rates from the tokens to the various types of network credits.

Although embodiments are generally described as a single internal treasury of networking credits being used by participants to access a single mesh network, embodiments are not so limited. Rather, in some embodiments, separate token-to-network credit exchange computing system 104 having separate or distinct networking credits may be employed for separate mesh networks. These separate mesh networks may be separated by participant computing devices, capabilities, security levels, or the like. For example, a first group of participant computing devices may utilize a first token-to-network credit exchange computing system 104 to obtain first network credits to access a first mesh network that is operating with a first, high-level security protocol. A second group of participant computing devices may utilize a second token-to-network credit exchange computing system 104 to obtain second network credits to access a second mesh network that is operating with a second, low-level security protocol, where the second network credits are separate and distinct from the first network credits. In some embodiments, the first group of participant computing devices may include one or more of the same participant computing devices as the second group of participant computing devices, where those same participant computing devices are capable of participating in the separate mesh networks using separate network credits. In other embodiments, the same network credits may be used in both the first and second mesh networks.

In some embodiments, users may be incentivized to upgrade or improve their participant computing devices, or to add new participant computing devices to the mesh network 114. For example, the system may select a different route when transmitting data from participant computing device 106a to participant computing device 106c in an effort to incentivize users to improve the mesh network. For example, a route through participant computing device 106b may be selected if participant computing device 106b is upgraded from a low throughput participant computing device to a higher throughput participant computing device (e.g., from a tier 1 mobile participant to a tier 2 mobile participant). As another example, a route through participant computing device 106b may be selected if a new participant computing device (not illustrated) is added to the mesh network 114 such that it can transmit messages and data between the participant computing device 106b and the participant computing device 106c. The selection of different routes allows for the re-distribution of network credits to other users or the re-distribution of network credits to users in different portions.

Although FIG. 1 illustrates five participant computing devices 106a-106e as creating the mesh network 114, embodiments are not so limited. Rather, the mesh network 114 may be made up of any combination of two or more participant computing devices 106 that comprise stationary participant computing devices or mobile participant computing devices, or some combination thereof. As a result, the mesh network 114 may comprise one or more mobile participant computing devices and one or more stationary participant computing devices, in some embodiments. In other embodiments, the mesh network 114 may comprise a plurality of mobile participant computing devices and no stationary participant computing devices. In yet other embodiments, the mesh network 114 may comprise a plurality of stationary participant computing devices and no mobile participant computing devices.

As mentioned above, participant computing devices can be mobile or stationary and may be one of a plurality of different types of participant computing devices. The different types of participant computing devices may be determined based on the different computing or networking capabilities of the devices.

For example, mobile participant computing devices may be tier 1 mobile participants, tier 2 mobile participants, or tier 3 mobile participants. The three tiers of mobile participants are generally separated by the computing and networking capabilities of the computing devices associated with the mobile participant. The computing and networking capabilities may be limited or determined by the amount of power available or utilized by a mobile computing device, the amount of processing power available, or the size, type, or accuracy of the antenna utilized, etc.

For example, tier 1 mobile participants typically have the smallest available power, lowest processing power, smallest bandwidth, shortest ranged antenna, lowest power output, lowest accuracy, and slowest update rate. Examples of tier 1 mobile participants include, but are not limited to, mobile phones, laptop computers, tablet computers, wearable computing devices, or other smaller, low power, low transmission mobile computing or Internet-Of-Things devices.

Tier 2 mobile participants typically have medium power constraints, a medium amount of processing power, medium bandwidth, medium range capabilities, medium accuracy, and medium update rate. Examples of tier 2 mobile participants include, but are not limited to, automobiles, small personal boats, personal aircrafts, or other medium power, medium transmission, power regenerating mobile computing devices or objects that can support such mobile computing devices.

Tier 3 mobile participants typically have the largest available power, highest processing power, highest bandwidth, longest transmit and receive capabilities, highest accuracy, and fastest update rate among mobile participant computing devices. Example tier 3 mobile participants include, but are not limited to, commercial airline planes, semi-trucks, cargo ships, trains, or other objects that can support larger, high power, high transmission mobile computing devices or objects that can support such mobile computing devices.

In some embodiments, one or more of these tiers may be further separated by capabilities or expected utilization. For example, tier 3 mobile participants may include tier 3A mobile participants that include cargo aircraft and tier 3B mobile participants that include commercial aircraft. One situation where this distinction may occur is where a commercial aircraft is handling a lot of data requests from user devices onboard the aircraft (e.g., tier 1 mobile participants), which may impact that aircraft's throughput for forwarding communications between other participants. Conversely, a cargo aircraft is typically not handling a lot of data requests from user devices onboard the aircraft, but is instead primarily being used to forward communications between other participants.

The stationary participant computing devices 104 may also be categorized based on their capabilities. For example, stationary participant computing devices 104 may include ground entry points, remote entry points, and access nodes. Similar to the three tiers of mobile participants, the ground entry points, remote entry points, and access nodes are generally separated by computing and networking capabilities, and footprint size in some embodiments.

For example, ground entry points typically have the largest available power, highest processing power, highest bandwidth, and longest range antenna capabilities. Example locations of ground entry points include, but are not limited to, cellular towers, airports, large retail or superstores, or other locations that can support large sized, high power, high transmission stationary computing devices.

Remote entry points typically have medium power constraints, a medium amount of processing power, medium bandwidth, and medium range capabilities. Example locations of remote entry points include, but are not limited to, restaurants and coffee shops, airfields and train stations, satellites, or other locations that can support medium sized, medium power, medium transmission stationary computing devices.

Access nodes typically have the smallest available power, lowest processing power, lowest bandwidth, and shortest range antenna capabilities of the stationary participants. Example locations of access nodes include, but are not limited to, road intersections, train crossings, road signs, mile markers, crosswalks, or other locations that can support smaller, low power, low transmission stationary computing devices.

These grouping of different types of participant computing devices is for illustration purposes and is not to be limiting.

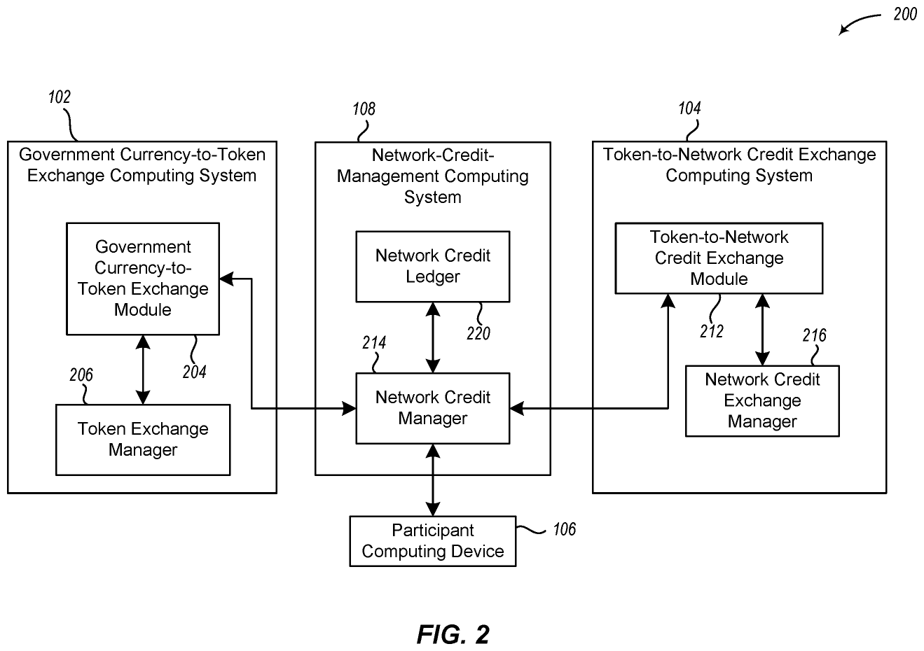

FIG. 2 illustrates a block diagram of components to facilitate the exchange of government currency to networking credits to enable a tokenized mesh network in accordance with embodiments described herein. Example system 200 includes a network-credit-management computing system 108, a government currency-to-token exchange computing system 102, and a token-to-network credit exchange computing system 104, which are similar to those computing system described in FIG. 1.

The government currency-to-token exchange computing system 102 includes a government currency-to-token exchange module 204 and a token exchange manager 206. The government currency-to-token exchange module 204 is configured to convert, exchange, or translate one or more types of government currencies into one or more types of tokens. This process may also be referred to as buying tokens. As discussed herein, the tokens may be cryptocurrency. The exchange from government currency to tokens may be based on an amount of government currency to be exchanged on behalf on one or more users of participant computing devices 106 and a current exchange rate from the government currency to the tokens.

The government currency-to-token exchange module 204 coordinates the recording and management of the tokens with the token exchange manager 206. The token exchange manager 206 may manage or track the ownership of the tokens after they have been secured in response to the exchange from the government currency to the tokens. In various embodiments, the token exchange manager 206 may be part of a blockchain or other secure computing environment that tracks and manages the tokens. In at least one embodiment, the tokens may be purchased or acquired in the name of the company supporting or hosting the mesh network, such as the company maintaining the network-credit-management computing system 108 and the token-to-network credit exchange computing system 104.

The token-to-network credit exchange computing system 104 includes a token-to-network credit exchange module 212 and a network credit exchange manager 216. The token-to-network credit exchange module 212 is configured to convert, exchange, or translate one or more types of tokens into one or more types of network credits. As discussed herein, the network credits may be routing credits, processing credits, or storage credits. The exchange from the tokens to network credits may be based on an amount of tokens obtained from the exchange from government currency to tokens and a current exchange rate from the tokens to the network credits. In various embodiments, different exchange rates may be maintained for different types of network credits.

The token-to-network credit exchange module 212 coordinates the recording and management of the network credits with the network credit exchange manager 216. The network credit exchange manager 216 may manage or track the ownership of the network credits after they have been secured in response to the exchange from the tokens into the network credits. In various embodiments, the network credit exchange manager 216 may be part of a blockchain or other secure computing environment that tracks and manages the network credits.

The network-credit-management computing system 108 includes a network credit manager 214 and a network credit ledger 220. The network credit manager 214 coordinates with the government currency-to-token exchange computing system 102 and the token-to-network credit exchange computing system 104 to exchange government currency from the user of the participant computing device 106. For example, the network credit manager sends a request to the government currency-to-token exchange module to exchange an amount of government currency into tokens. Upon completion of the exchange, the government currency-to-token exchange module 204 sends a message to the network credit manager 214 indicating the successful exchange.

The network credit manger 214 then stores a record in the network credit ledger 220 of the tokens obtained for the user. The network credit manager 214 then sends a request to the token-to-network credit exchange module 212 to exchange the tokens into network credits. As discussed herein, this request may indicate which types of network credits (routing credits, processing credits, or storage credits) to obtain and the amount or percentage of each type. Upon completion of the exchange, the token-to-network credit exchange module 212 sends a message to the network credit manager 214 indicating the successful exchange. The network credit manger 214 then stores a record in the network credit ledger 220 of the network credits obtained for the user.

As the participant computing device 106 accesses or uses the network, as described herein, the participant computing device 106 communicates that access with the network credit manager 214. The network credit manager 214 then determines a type and number of network credits to deduct from the participant computing device 106 for that access. The network credit manager 214 then deducts those network credits from the record stored for the user in the network credit ledger. The network credit manager 214 may in turn re-distribute or re-allocate those network credits to other users whose participant computing devices enabled the user's access of the network. In various embodiments, the network credit manager 214 updates the records of those users in the network credit ledger 220 to capture the re-distribution or re-allocation of network credits.

Although embodiments are described with the network credit manager 214 and the network credit ledger 220 as being employed by the network-credit-management computing system 108, embodiments are not so limited. In some embodiments, the network credit manager 214 and the network credit ledger 220 may be employed by the token-to-network credit exchange computing system 104 or some other computing device or system. In at least one embodiment, the network credit ledger 220 may be part of or employed by the network credit exchange manager 216 of the token-to-network credit exchange computing system 104.

In various embodiments, the network credit manager 216 may manage the exchange of the user's network credits back into government currency. For example, the network credit manager 216 may employ the token-to-network credit exchange module 212 to exchange the user's network credits back into tokens. The network credit manager 214 can then employ the government currency-to-token exchange module 204 to exchange the tokens into government currency, which is then provided to the user.

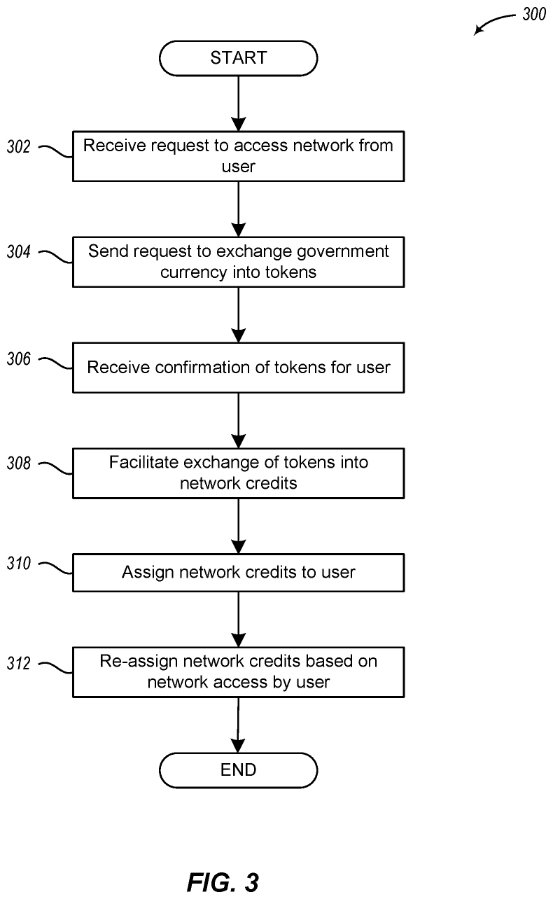

The operation of certain aspects will now be described with respect to FIGS. 3-7. In at least one of various embodiments, processes 300, 400, 500, 600, and 700 described in conjunction with FIGS. 3-7, respectively, may be implemented by or executed on one or more computing devices, such as network-credit-management computing system 108 in FIG. 1, token-to-network credit exchange computing system 104 in FIG. 1, or some combination thereof.

FIG. 3 illustrates a logical flow diagram showing one embodiment of a process 300 for employing a tokenized mesh network in accordance with embodiments described herein.

Process 300 begins, after a start block, at block 302, where a request to access or utilize a network is received from a user. In various embodiments, a user may utilize a website or computer application to register with the network to access the network. This registration may include or initiate the request for the user to access the network. In other embodiments, a participant device of the user may send the request when being configured for the user or when trying to access or use the network.

As described herein, the network may be a mesh network that is made up of a plurality of participant computing devices. Thus, the access request may be a request to communicate with other participant computing devices or otherwise participate in the mesh network. Participating in the network may include the participant computing device of the user being a node in the network to route messages, process data, or store data for other users.

Process 300 proceeds to block 304, where a request is sent to another service or computing system, e.g., government currency-to-token exchange computing system 102 in FIG. 1, to exchange government currency into tokens. In various embodiments, the request received in block 302 may include a dollar amount that is to be exchanged into network credits. But before the user has network credits, the dollars or government currency provided by the user is exchanged into tokens. In some embodiments, the dollars or government currency from a plurality of users may be aggregated, and this aggregated dollar amount may be exchanged for tokens. The system can then track the ratio of dollars-to-tokens for each of the plurality of users.

Although embodiments are described herein as exchanging dollars or government currency into tokens, embodiments are not so limited. In other embodiments, cryptocurrency or other types of real or virtual currency or goods may be exchanged for tokens.

Process 300 continues at block 306, where a confirmation of the tokens is received for the user. In at least one embodiment, this confirmation is a message provided by the service or computing system, e.g., government currency-to-token exchange computing system 102, which exchanged the government currency into tokens. The message confirms that the exchange occurred and identifies the number of tokens obtained for the user.

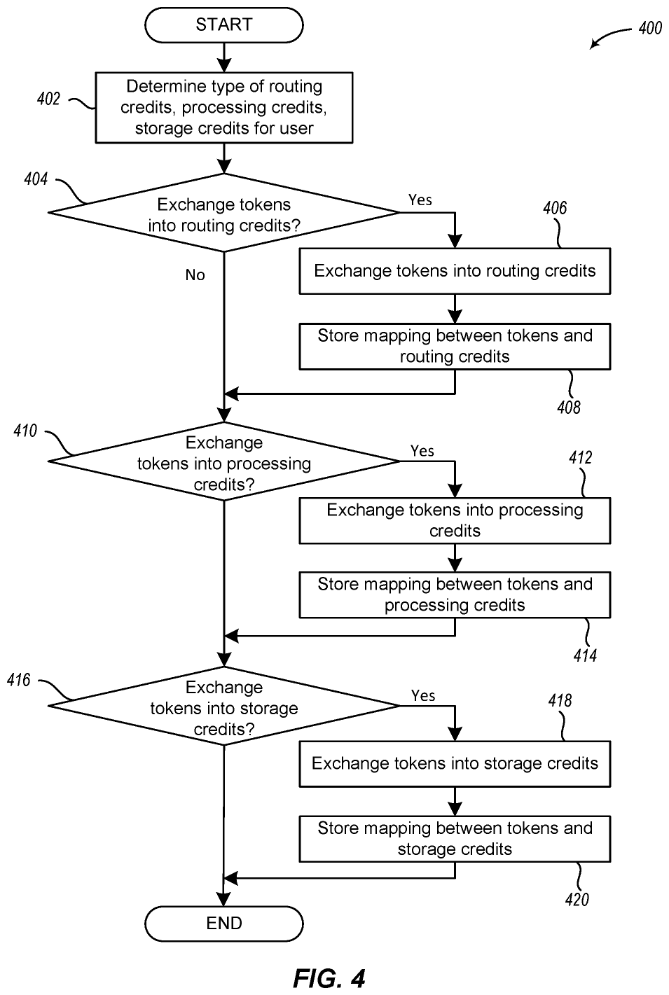

Process 300 proceeds next to block 308, where the tokens are exchanged into network credits, which is described in more detail below in conjunction with FIG. 4. Briefly, however, an internal registry, such as the token-to-network credit exchange computing system 104 in FIG. 1, utilizes set exchange rates to exchange the tokens into network credits, which may include a number of routing credits, a number of processing credits, or a number of storage credits, or some combination thereof.

Process 300 continues next at block 310, where the network credits are assigned to the user. In various embodiments, this assignment or allocation includes maintaining a ledger, record, or mapping of the network credits that can be used by the user, such as by storing such information in the network credit ledger 220 in FIG. 2.

In some embodiments, a single ledger, record, or mapping of the network credits to the user is maintained. Accordingly, the user may have a single electronic wallet that identifies a current number of network credits assigned to that user. In other embodiments, a separate ledger, record, or mapping of the different types network credits to the user is maintained. For example, a first ledger, record, or mapping may be maintained to identify the number of routing credits assigned to the user; a second ledger, record, or mapping may be maintained to identify the number of processing credits assigned to the user; and a third ledger, record, or mapping may be maintained to identify the number of storage credits assigned to the user. Accordingly, the user may have multiple electronic wallets that identifies a current number of network credits assigned to that user for the different types of network credits.

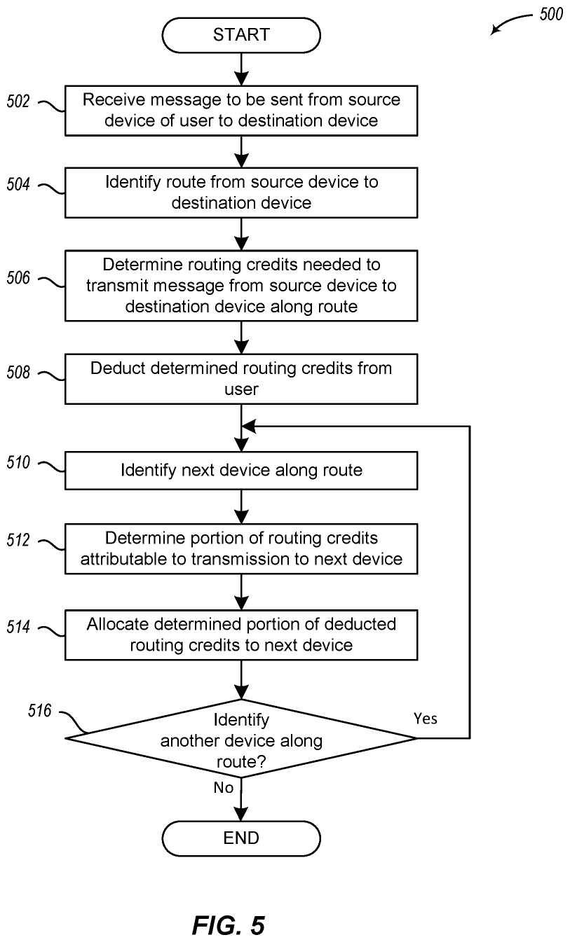

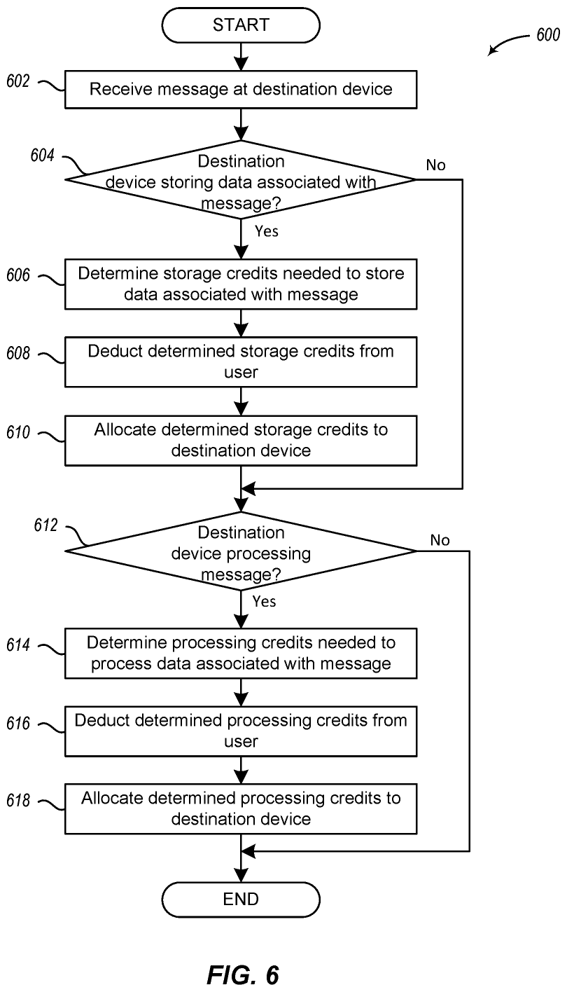

Process 300 proceeds to block 312, where network credits are re-assigned, re-distributed, or re-allocated based on the network access by the user, which is described in more detail below in conjunction with FIGS. 5 and 6.

Briefly, when a user accesses the network, the user's network credits are deducted based on the type and amount of access. For example, if the network is transmitting data from a source device to a destination device, then the user's routing credits may be deducted based on the amount of data to be transferred or how the data is routed from the source device to the destination device or some combination thereof. As another example, if the user is having a destination device store data for the user, then the user's storage credits may be deducted based on the amount of data being stored or the duration of the storage or some combination thereof. In yet another example, if the user is having a destination device perform specific processing on the user's data, then the user's processing credits may be deducted based on the amount of data being processed or the time to process the data or the type of processing or some combination thereof. The ledger, record, or mapping that is maintained for the user's network credits can then be deducted according to the user's use or access of the network.

The deducted credits are then provided to the users whose participant devices serviced that access. Accordingly, a user may earn network credits when their participant device is used by other users who are accessing the network. For example, if another user is transmitting data from a source participant device to a destination device and the user's participant device is being used to forward or transmit data along the route from the source participant device to the destination device, then the user's routing credits may be increased based on the amount of data transferred or how the data is routed from the source participant device to the destination device or some combination thereof.

As another example, if the user's participant computing device is storing data for another user, then the user's storage credits may be increased based on the amount of data being stored or the duration of the storage or some combination thereof. In yet another example, if the user's participant computing device is performing specific processing for another user's data, then the user's processing credits may be increased based on the amount of data being processed or the time to process the data or the type of processing or some combination thereof. The ledger, record, or mapping that is maintained for the user's network credits can then be increased according to how the user's participant computing device is uses to enable another user to access the network.

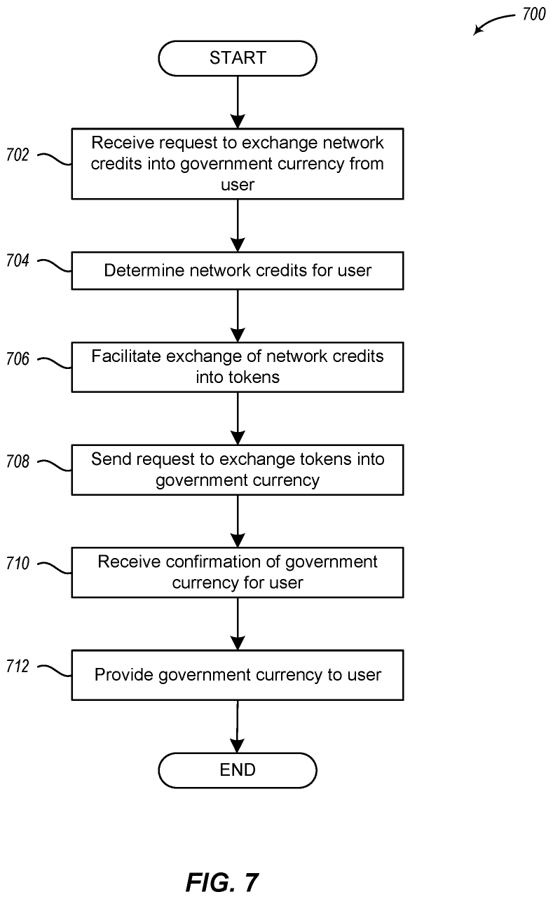

After block 312, process 300 terminates or otherwise returns to a calling process to perform other actions. For example, process 700 in FIG. 7 may be called to convert or exchange a user's network credits into government currency. Moreover, process 300 may continue to re-assign network credits at block 312 as the user makes subsequent network access requests, although FIG. 3 does not illustrate this looping.

FIG. 4 illustrates a logical flow diagram showing one embodiment of a process 400 for exchanging government currency into network credits in accordance with embodiments described herein.

Process 400 begins, after a start block, at block 402, where a type of credits are to be provided or allocated to the user. In some embodiments, the requested received at block 302 in FIG. 3 from the user may indicate which types of credits the user would like to obtain to access the network. For example, the request can indicate that the user would like routing credits, processing credits, or storage credits, or some combination thereof. The request may also indicate a number, percentage, or ratio of different credit types.

For example, the request may indicate that the user wants 75% routing credits, 20% processing credits, and 5% storage credits. As described herein, the user's government currency is first exchanged into tokens, which are then exchanged into network credits. The use of percentages allows for the number of network credits to change based on aggregated exchanges rates from government currency to tokens, from tokens to routing credits, from tokens to processing credits, and from tokens to storage credits.

As another example, the request may indicate that the user wants 100 routing credits, and any remaining network credits that can be obtained via the exchanges from government currency to tokens and from tokens to the different network credits.

Process 400 proceeds to decision block 404, where a determination is made whether the request is to exchange tokens into routing credits for the user. If the request is to exchange tokens into routing credits for the user, then process 400 flows to block 406; otherwise, process 400 flows to decision block 410.

At block 406, at least a portion of the tokens are exchanged into routing credits based on a current exchange rate between tokens and routing credits. As discussed above, the request may indicate how many or a percentage of routing credits. This information is then used to select the number of tokens that are exchanged into routing credits. As discussed herein, an internal exchange system, such as token-to-network credit exchange computing system 104 in FIGS. 1 and 2 is used to exchange or convert the tokens into routing credits.

Process 400 continues to block 408, where a mapping between the tokens and the routing credits is stored for the user. In various embodiments, this mapping logs or identifies how many of the tokens, as owned by the system, were used or reserved for the user to obtain the routing credits. In some embodiments, the system may not identify the user as part of this mapping, but stores or assigns the routing credits to the user separately, such as at block 310 in FIG. 3. After block 408, process 400 proceeds next to decision block 410.

At decision block 410, a determination is made whether the request is to exchange tokens into processing credits for the user. If the request is to exchange tokens into processing credits for the user, then process 400 flows to block 412; otherwise, process 400 flows to decision block 416.

At block 412, at least a portion of the tokens are exchanged into processing credits based on a current exchange rate between tokens and processing credits. As discussed above, the request may indicate how many or a percentage of processing credits. This information is then used to select the number of tokens that are exchanged into processing credits. As discussed herein, an internal exchange system, such as token-to-network credit exchange computing system 104 in FIGS. 1 and 2 is used to exchange or convert the tokens into processing credits.

Process 400 continues to block 4141, where a mapping between the tokens and the processing credits is stored for the user. In various embodiments, this mapping logs or identifies how many of the tokens, as owned by the system, were used or reserved for the user to obtain the processing credits. In some embodiments, the system may not identify the user as part of this mapping, but stores or assigns the processing credits to the user separately, such as at block 310 in FIG. 3. After block 414, process 400 proceeds next to decision block 416.

At decision block 416, a determination is made whether the request is to exchange tokens into storage credits for the user. If the request is to exchange tokens into storage credits for the user, then process 400 flows to block 418; otherwise, process 400 terminates or otherwise returns to a calling process to perform other actions.

At block 418, at least a portion of the tokens are exchanged into storage credits based on a current exchange rate between tokens and storage credits. As discussed above, the request may indicate how many or a percentage of storage credits. This information is then used to select the number of tokens that are exchanged into storage credits. As discussed herein, an internal exchange system, such as token-to-network credit exchange computing system 104 in FIGS. 1 and 2 is used to exchange or convert the tokens into storage credits.

Process 400 continues to block 420, where a mapping between the tokens and the storage credits is stored for the user. In various embodiments, this mapping logs or identifies how many of the tokens, as owned by the system, were used or reserved for the user to obtain the storage credits. In some embodiments, the system may not identify the user as part of this mapping, but stores or assigns the storage credits to the user separately, such as at block 310 in FIG. 3. After block 420, process 400 terminates or otherwise returns to a calling process to perform other actions.

FIG. 5 illustrates a logical flow diagram showing embodiments of processes 500 for utilizing network credits to route messages in accordance with embodiments described herein.

Process 500 begins, after a start block, at block 502, where a message is received. This message is to be sent from a source device, such as mobile participant 106 or stationary participant 104, of the user to a destination device, such as another mobile participant 106 or another stationary participant 104.

Process 500 proceeds to block 504, where a route is identified from the source device to the destination device. In various embodiments, this route may be identified as a fastest route or fewest hops route (i.e., forwarding transmissions by other intermediate participant computing devices).

In various embodiments, the route may also be selected or influenced by system incentives. In some embodiments, the system may incentivize users in the network to update or upgrade their participant computing devices to be faster, transmit higher bandwidths, use less power, etc. For example, a user that has and maintains a stationary access node may be incentivized to upgrade to a stationary remote entry point (i.e., a computing device having higher power constraints, higher processing power, higher bandwidth, or higher range capabilities, or some combination thereof). If a user did in fact update or upgrade their participant computing device, then the route may be selected to include this participant computing device. In this way, the updated or upgraded participant computing device forwards more messages and thus its user collects more routing credits for forwarding those messages.

In other embodiments, the system may incentivize users to bring new participant devices into the network in particular geographical areas. If user did in fact add a participant computing device in that area, then the route may be selected to include this participant computing device. In this way, the new participant computing devices may forward more messages and thus its user collects more routing credits for forwarding those messages.

If multiple participant computing devices are updated or upgraded or added to the network, then one or more balancing algorithms or weighting algorithms may be employed based on the types or amounts of upgrades, the amount of network traffic, the load on a particular device, how close the new participant device is to a target location, etc.

Process 500 continues at block 506, where a number of routing credits are determined to transmit the message from the source device to the destination device along the route. In various embodiments, the number of routing credits may be selected or changed in response to the number of hops along the route, the current network traffic load, the size of the message, the type of message (e.g., high-security message vs. low-security message), the type of data (e.g., highly encrypted data vs. non-encrypted website data), the user (e.g., corporate vs. individual), whether a message or data is to be returned to the user, an amount of data to be returned to the user, or other factors, or some combination thereof.

Process 500 proceeds next to block 508, where the determined routing credits are deducted from the user. In various embodiments, the ledger, record, or mapping that maintains the number of routing credits assigned to the user is modified to show the deducted routing credits. In some embodiments, this deduction of routing credits may be performed prior to transmitting the message along the route to the destination device. In other embodiments, the deduction may occur after successful transmission of the message from the source device to the destination device.

Process 500 continues next at block 510, where a next device along the route is identified. This next device is a next intermediate participant computing device that is to transmit or forward the message along the route from the source device to the destination device.

Process 500 proceeds to block 512, where a portion of the routing credits attributable the transmission of the message are determined for the next device. In some embodiments, the routing credits determined at block 506 are evenly distributed among all intermediate participant device along the route between the source device and the destination device. In other embodiments, the portion of routing credits attributable to the next device may be selected based the capabilities of the next device, the load on the next device, a priority that the next device is assigning to the message, update or upgrade incentives, etc. In this way, the routing credits determined at block 506 may not be evenly distributed among all intermediate participant device along the route between the source device and the destination device. These unequal routing credit distributions can be used to further incentives users to upgrade or update their participant device.

In various embodiments, the destination device may be outside of the mesh network. In at least one such embodiment, the portion of the routing credits attributable the transmission of the message may be determined for those next participant computing devices within the mesh network.

Process 500 continues at block 514, where the determined portion of deducted routing credits are re-allocated or re-assigned to the user of the next device. In various embodiments, the ledger, record, or mapping that maintains the number of routing credits assigned to the user of the next device is modified to show the re-allocated or re-assigned portion of routing credits.

Process 500 proceeds next to decision block 516, where a determination is made whether another device along the route is to be identified. In various embodiments, this determination is based on the route between the source device and the destination device and whether each intermediate participant device has been identified and provided its portion of the routing credits. If another device along the route is to be identified, process 500 loops to block 510; otherwise, process 500 terminates or otherwise returns to a calling process to perform other embodiments.

In various embodiments, process 500 may be performed by the token-to-network credit exchange computing system 104 (e.g., network credit manager 214) in FIG. 2 in response to receiving a network access request from the source device indicating that the source device intends to send a message. In at least one embodiment, the actual transmission and forwarding of the message may be performed by the intermediate participant devices that are along the route from the source device to the destination device. In some embodiments, these intermediate participant devices may perform the transmission or forwarding of the message without any further input or feedback from the token-to-network credit exchange computing system 104. In other embodiments, the intermediate participant devices may perform the transmission or forwarding of the message in response to an affirmative indication from the token-to-network credit exchange computing system 104 indicating that the routing credits attributable to that intermediate participant device have been re-allocated or re-assigned to that intermediate participant device.

FIG. 6 illustrates a logical flow diagram showing embodiments of processes 600 for utilizing network credits to process data or store data in accordance with embodiments described herein.

Process 600 begins, after a start block, at block 602, where a message is received at a destination device, such as after it is routed from a source device via one or more intermediate participant devices. This destination device may be the same destination device mentioned in block 502 in FIG. 5. In other embodiments, this destination device may be an intermediate participant device along a route in which the data associated with the message is to be processed or stored.

Process 600 proceeds to decision block 604, where a determination is made whether the destination device is storing data associated with the message. In various embodiments, the message may include metadata or other information indicating which participant device is the destination device and whether it is storing data associated with the message. If the destination device is storing data, then process 600 flows to block 606; otherwise, process 600 flows to decision block 612.

At block 606, an amount of storage credits needed to store the data is determined. In various embodiments, the message may indicate an amount of data and an amount of time in which the data is to be stored. The amount of storage credits may be then be determined or calculated based on the amount of data and the time in which it is to be stored. In other embodiments, the type of data to be stored may also be utilized to determine the amount of storage credits. For example, storage of highly sensitive data may require more storage credits than the storage of non-sensitive data.

Process 600 proceeds to block 608, where the determined storage credits are deducted from the user associated with the data. In various embodiments, the ledger, record, or mapping that maintains the number of storage credits assigned to the user is modified to show the deducted storage credits. In some embodiments, this deduction of storage credits may be performed prior to storage of the data. In other embodiments, the deduction may occur periodically during the storage period or after successful storage and release of the data.

Process 600 continues to block 610, where the determined storage credits are re-allocated or re-assigned to the destination device that is storing in the data. In various embodiments, the ledger, record, or mapping that maintains the number of storage credits assigned to the user of destination device is modified to show the re-allocated or re-assigned portion of storage credits.

Process 600 proceeds next to decision block 612, where a determination is made whether the destination device is processing the message or data associated with the message. In various embodiments, the message may include metadata or other information indicating which participant device is the destination device and whether it is processing the message or the data associated with the message. If the destination device is processing the data or the message, then process 600 flows to block 614; otherwise, process 600 terminates or otherwise returns to a calling process to perform other actions.

At block 614, an amount of processing credits needed to process the message or the data associated with the message is determined. In various embodiments, the message may indicate an amount of data to be processed and the type of processing to be performed. The amount of processing credits may be then be determined or calculated based on the amount of data to be processed and the type of processing to be performed.

Process 600 proceeds to block 616, where the determined processing credits are deducted from the user associated with the data. In various embodiments, the ledger, record, or mapping that maintains the number of processing credits assigned to the user is modified to show the deducted processing credits. In some embodiments, this deduction of processing credits may be performed prior to processing of the data. In other embodiments, the deduction may occur periodically during the processing of the data or after successfully processing the data.

Process 600 continues to block 618, where the determined processing credits are re-allocated or re-assigned to the destination device that is processing in the data. In various embodiments, the ledger, record, or mapping that maintains the number of processing credits assigned to the user of destination device is modified to show the re-allocated or re-assigned portion of processing credits.

After block 618, process 600 terminates or otherwise returns to a calling process to perform other actions.

FIG. 7 illustrates a logical flow diagram showing one embodiment of a process 700 for exchanging network credits into government currency in accordance with embodiments described herein.

Process 700 begins, after a start block, at block 702, where a request to exchange network credits into government currency is received from a user. In various embodiments, a user may utilize a website or computer application to request the exchange of one or more network credits (e.g., one or more routing credits, one or more processing credits, or one or more storage credits, or some combination thereof) into government currency.

Process 700 proceeds to block 704, where a number and type of networks credits to exchange for the user is determined. In various embodiments, the request itself may indicate the number of network credits to exchange. In other embodiments, the user's ledger or wallet may be accessed to identify the number of network credits available to exchange. In some embodiments, a graphical user interface may be displayed to the user to enable the user to select the network credits to be exchanged into government currency.

Process 700 continues at block 706, where the exchange from network credits to tokens is facilitated. In some embodiments, a request is sent to the token-to-network credit exchange computing system 104 in FIG. 1 to exchange the network credits into tokens. The token-to-network credit exchange computing system 104 utilizes set exchange rates to exchange the network credits into tokens. Accordingly, a number of routing credits, a number of processing credits, or a number of storage credits, or some combination thereof are exchanged into tokens based on the exchange rate between routing credits and tokens, the exchange rate between processing credits and tokens, and the exchange rate between storage credits and tokens.

Process 700 proceeds next to block 708, where a request is sent to another service or computing system, e.g., government currency-to-token exchange computing system 102 in FIG. 1, to exchange the tokens obtain in block 706 into government currency. As described herein, the government currency may be U.S. dollars, cryptocurrency, or other virtual or real currency.

Process 700 continues next to block 710, where a confirmation of the government tokens is received for the user. In at least one embodiment, this confirmation is a message provided by the service or computing system, e.g., government currency-to-token exchange computing system 102, which exchanged the tokens into government currency. The message confirms that the exchange occurred and identifies the government currency obtain for the user in response to the number of tokens provided.

Process 700 proceeds next to block 712, where the government currency is provided to the user. In some embodiments, a bank account, electronic wallet, or other electronic currency storage facility of the user may be updated with the government currency.

After block 712, process 700 terminates or otherwise returns to a calling process to perform other actions.

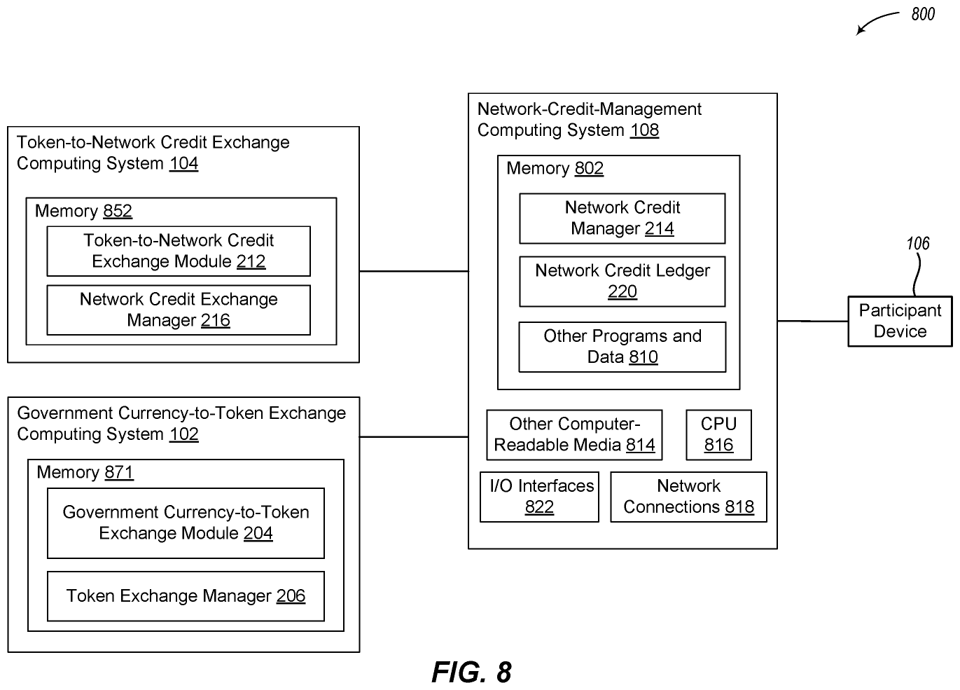

FIG. 8 shows a system diagram that describes one implementation of computing systems for implementing embodiments described herein. System 800 includes a token-to-network credit exchange computing system 104, a network-credit-management computing system 108, and a government currency-to-token exchange computing system 102.

The network-credit-management computing system 108 is configured to communicate with one or more participant computing devices 106 and to manage the exchange, storage, and upkeep of network credits for the users of the participant computing devices 106. One or more special-purpose computing systems may be used to implement the network-credit-management computing system 108. Accordingly, various embodiments described herein may be implemented in software, hardware, firmware, or in some combination thereof. The network-credit-management computing system 108 may include memory 802, one or more central processing units (CPUs) 816, I/O interfaces 822, other computer-readable media 814, and network connections 818.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 802 may be utilized to store information, including computer-readable instructions that are utilized by CPU 816 to perform actions, including embodiments described herein.

Memory 802 may have stored thereon network credit manager 214 and a network credit ledger 220. The network credit manager 214 coordinates the exchange of government currency into tokens and from the tokens into network credits, as described herein. Moreover, the network credit manager 214 manages, deducts, and re-allocates or re-assigns network credits from the network credit ledger 220 as participant computing devices access or utilize the network, as described herein. The memory 802 may also store other programs or data 810, such as user profiles, participant computing device profiles, etc.

Network connections 818 are configured to communicate with participant computing devices 106, the token-to-network credit exchange computing system 104, and the government currency-to-token exchange computing system 102 user of the participant computing device 106. The network connections 818 may include one or more transceivers (not illustrated) to send or receive data. I/O interfaces 822 may include a display, keyboard, audio or video interfaces, or the like. Other computer-readable media 814 may include other types of stationary or removable computer-readable media, such as removable flash drives, external hard drives, or the like.

The token-to-network credit exchange computing system 104 is configured to communicate with network-credit-management computing system 108 to exchange tokens into network credits, as described herein. One or more special-purpose computing systems may be used to implement the token-to-network credit exchange computing system 104. Accordingly, various embodiments described herein may be implemented in software, hardware, firmware, or in some combination thereof. The token-to-network credit exchange computing system 104 may include memory 852. The token-to-network credit exchange computing system 104 also includes one or more central processing units (CPUs), I/O interfaces, other computer-readable media, and network connections, similar to those computing components of the network-credit-management computing system 108.

Memory 852 may include one or more various types of non-volatile and/or volatile storage technologies, similar to memory 802. Memory 852 may be utilized to store information, including computer-readable instructions that are utilized by one or more CPUs to perform actions, including some embodiments described herein.

Memory 852 may have stored thereon a token-to-network credit exchange module 212 and a network credit exchange manager 216. The token-to-network credit exchange module 212 and the network credit exchange manager 216 facilitate the exchange of tokens into network credits and the exchange of network credits into tokens, as described herein. Although the token-to-network credit exchange module 212 and the network credit exchange manager 216 are illustrated as separate computing components, embodiments are not so limited and one or more computing components may be employed to perform the functionality of the token-to-network credit exchange module 212 and the network credit exchange manager 216.

The government currency-to-token exchange computing system 102 is configured to communicate with network-credit-management computing system 108 to exchange government currency into tokens, as described herein. One or more special-purpose computing systems may be used to implement the government currency-to-token exchange computing system 102. Accordingly, various embodiments described herein may be implemented in software, hardware, firmware, or in some combination thereof. The government currency-to-token exchange computing system 102 may include memory 871. The government currency-to-token exchange computing system 102 also includes one or more central processing units (CPUs), I/O interfaces, other computer-readable media, and network connections, similar to those computing components of the network-credit-management computing system 108.

Memory 871 may include one or more various types of non-volatile and/or volatile storage technologies, similar to memory 802. Memory 871 may be utilized to store information, including computer-readable instructions that are utilized by one or more CPUs to perform actions, including some embodiments described herein.

Memory 871 may have stored thereon a government currency-to-token exchange module 204 and a token exchange manager 206. The government currency-to-token exchange module 204 and a token exchange manager 206 facilitate the exchange of government currency into tokens and the exchange of tokens into government currency, as described herein. Although the government currency-to-token exchange module 204 and a token exchange manager 206 are illustrated as separate computing components, embodiments are not so limited and one or more computing components may be employed to perform the functionality of the government currency-to-token exchange module 204 and the token exchange manager 206

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by a computing device from a user, a request to access a network;
sending, by the computing device, the request to a government currency-to-token exchange to exchange government currency into tokens for the user;
receiving, by the computing device, confirmation of the tokens for the user;
facilitating, by the computing device, exchange of the tokens into network credits for the user to access the network;
assigning, by the computing device, the network credits to the user;
receiving, by the computing device, a network-access request associated with the user;
re-assigning, by the computing device, a portion of the network credits for the user based on the network-access request; and
enabling, by the computing device, access to the network for the network-access request in response to the re-assignment of the portion of the network credits for the user.

2. The method of claim 1, wherein facilitating exchange of the tokens into the network credits comprises:
determining, by the computing device, that the network credits are to be routing credits;
determining, by the computing device, an exchange rate between routing credits and the tokens; and
determining, by the computing device, a number of routing credits for the user based on the tokens and the exchange rate.

3. The method of claim 1, wherein facilitating exchange of the tokens into the network credits comprises:
determining, by the computing device, that the network credits are to be storage credits;
determining, by the computing device, an exchange rate between storage credits and the tokens; and
determining, by the computing device, a number of storage credits for the user based on the tokens and the exchange rate.

4. The method of claim 1, wherein facilitating exchange of the tokens into the network credits comprises:
determining, by the computing device, that the network credits are to be processing credits;
determining, by the computing device, an exchange rate between processing credits and the tokens; and
determining, by the computing device, a number of processing credits for the user based on the tokens and the exchange rate.

5. The method of claim 1, wherein facilitating exchange of the tokens into the network credits comprises:
determining, by the computing device, a first exchange rate between routing credits and the tokens;
determining, by the computing device, a second exchange rate between storage credits and the tokens;
determining, by the computing device, a third exchange rate between processing credits and the tokens;
identifying, by the computing device, a first number of tokens to exchange into routing credits;
identifying, by the computing device, a second number of tokens to exchange into storage credits;
identifying, by the computing device, a third number of tokens to exchange into processing credits;
determining, by the computing device, a first number of routing credits for the user based on the first number tokens and the first exchange rate;
determining, by the computing device, a second number of routing credits for the user based on the second number tokens and the second exchange rate; and
determining, by the computing device, a third number of routing credits for the user based on the third number tokens and the third exchange rate.

6. The method of claim 1, wherein facilitating exchange of the tokens into the network credits comprises:
determining, by the computing device, an exchange rate between network credits and the tokens;
identifying, by the computing device, a first number of tokens to exchange into routing credits;
identifying, by the computing device, a second number of tokens to exchange into storage credits;
identifying, by the computing device, a third number of tokens to exchange into processing credits;
determining, by the computing device, a first number of routing credits for the user based on the first number tokens and the exchange rate;
determining a second number of routing credits for the user based on the second number tokens and the exchange rate; and
determining, by the computing device, a third number of routing credits for the user based on the third number tokens and the exchange rate.

7. The method of claim 1, wherein re-assigning the portion of the network credits for the user based on the network-access request comprises:
deducting, by the computing device, the portion of the network credits from the user based on the network-access request; and
assigning, by the computing device, the portion of the network credits to at least one other user based on the network-access request.

8. The method of claim 1, wherein re-assigning the portion of the network credits for the user based on the network-access request comprises:
determining, by the computing device, that the network-access request is to transmit a message from a source device associated with the user to a destination device;
determining, by the computing device, a route from the source device to the destination device;
determining, by the computing device, a number of routing credits of the network credits associated with the route;
deducting, by the computing device, the number of routing credits from the user; and
assigning, by the computing device, the number of routing credits to at least one other user along the route.

9. The method of claim 1, wherein re-assigning the portion of the network credits for the user based on the network-access request comprises:
determining, by the computing device, that the network-access request is to store data for the user;
determining, by the computing device, a destination device that is to store the data for the user;
determining, by the computing device, a number of storage credits of the network credits associated with the storage of the data for the user;
deducting, by the computing device, the number of storage credits from the user; and
assigning, by the computing device, the number of storage credits to another user associated with the destination device.

10. The method of claim 1, wherein re-assigning the portion of the network credits for the user based on the network-access request comprises:
determining, by the computing device, that the network-access request is to process data for the user;
determining, by the computing device, a destination device that is to process the data for the user;
determining, by the computing device, a number of processing credits of the network credits associated with the processing of the data for the user;
deducting, by the computing device, the number of processing credits from the user; and
assigning, by the computing device, the number of processing credits to another user associated with the destination device.

11. A computing system, comprising:
a memory that stores computing instructions and network credit allocations for a plurality of users; and
a processor that executes the computing instructions to:
receive a request for a user of the plurality of users to access a network;
employ a government currency-to-token exchange to exchange government currency into tokens for the user;
facilitate exchange of the tokens into network credits for the user to access the network, wherein the network credits include any combination of routing credits, storage credits, or processing credits;
allocate the network credits to the user;
receive a network-access request associated with the user;
determine at least one computing device associated with the network-access request;
identify at least one other user associated with the at least one computing device; and
enable access to the network for the network-access request, including re-allocation of a portion of the network credits from the user to the at least one other user based on the network-access request.

12. The computing system of claim 11, wherein the processor facilitates the exchange of the tokens into the network credits by further executing the computing instructions to:
determine that the network credits are to be routing credits;
determine an exchange rate between routing credits and the tokens; and
determine a number of routing credits for the user based on the tokens and the exchange rate.

13. The computing system of claim 11, wherein the processor facilitates exchange of the tokens into the network credits by further executing the computing instructions to:
determine that the network credits are to be storage credits;
determine an exchange rate between storage credits and the tokens; and
determine a number of storage credits for the user based on the tokens and the exchange rate.

14. The computing system of claim 11, wherein the processor facilitates exchange of the tokens into the network credits by further executing the computing instructions to:
determine that the network credits are to be processing credits;
determine an exchange rate between processing credits and the tokens; and
determine a number of processing credits for the user based on the tokens and the exchange rate.

15. The computing system of claim 11, wherein the processor facilitates exchange of the tokens into the network credits by further executing the computing instructions to:
determine a first exchange rate between routing credits and the tokens;
determine a second exchange rate between storage credits and the tokens;
determine a third exchange rate between processing credits and the tokens;
identify a first number of tokens to exchange into routing credits;
identify a second number of tokens to exchange into storage credits;
identify a third number of tokens to exchange into processing credits;
determine a first number of routing credits for the user based on the first number tokens and the first exchange rate;
determine a second number of routing credits for the user based on the second number tokens and the second exchange rate; and
determine a third number of routing credits for the user based on the third number tokens and the third exchange rate.

16. The computing system of claim 11, wherein the processor facilitates exchange of the tokens into the network credits by further executing the computing instructions to:
determine an exchange rate between network credits and the tokens;
identify a first number of tokens to exchange into routing credits;
identify a second number of tokens to exchange into storage credits;
identify a third number of tokens to exchange into processing credits;
determine a first number of routing credits for the user based on the first number tokens and the exchange rate;
determine a second number of routing credits for the user based on the second number tokens and the exchange rate; and
determine a third number of routing credits for the user based on the third number tokens and the exchange rate.

17. The computing system of claim 11, wherein the processor re-allocates the portion of the network credits by further executing the computing instructions to:
deduct the portion of the network credits from the user based on the network-access request; and
allocate the portion of the network credits to at least one other user based on the network-access request.

18. The computing system of claim 11, wherein the processor re-allocates the portion of the network credits by further executing the computing instructions to:
determine that the network-access request is to transmit a message from a source device associated with the user to a destination device;
determine a route from the source device to the destination device;
determine a number of routing credits of the network credits associated with the route;
deduct the number of routing credits from the user; and
allocate the number of routing credits to at least one other user along the route.

19. The computing system of claim 11, wherein the processor re-allocates the portion of the network credits by further executing the computing instructions to:
determine that the network-access request is to store data for the user;
determine a destination device that is to store the data for the user;
determine a number of storage credits of the network credits associated with the storage of the data for the user;
deduct the number of storage credits from the user; and
allocate the number of storage credits to another user associated with the destination device.

20. The computing system of claim 11, wherein the processor re-allocates the portion of the network credits by further executing the computing instructions to:
determine that the network-access request is to process data for the user;
determine a destination device that is to process the data for the user;
determine a number of processing credits of the network credits associated with the processing of the data for the user;
deduct the number of processing credits from the user; and
allocate the number of processing credits to another user associated with the destination device.

21. A non-transitory computer-readable storage medium that stores instructions that, when executed by a processor in a computing system of a first participant, cause the processor to perform actions, the actions comprising:
receiving a request for a user to access a network;
sending the request to a government currency-to-token exchange to exchange government currency into tokens for the user;
receiving confirmation of the tokens for the user;
facilitating exchange of the tokens into network credits for the user to access the network, wherein the network credits include routing credits, storage credits, and processing credits;
assigning the network credits to the user;
receiving a network-access request associated with the user;
identifying at least one computing device associated with the network-access request; and
for each corresponding computing device of the at least one computing device:
determining whether the corresponding computing device is to route a message for the user, process data for the user, or store data for the user network-access request;
in response to the corresponding computing device routing the message for the user:
deducting a portion of the routing credits from the user;
assigning the portion of routing credits to another user associated with the corresponding computing device; and
enabling the corresponding computing device to route the message for the user;
in response to the corresponding computing device processing data for the user:
deducting a portion of the processing credits from the user;
assigning the portion of the processing credits to the other user associated with the corresponding computing device; and
enabling the corresponding computing device to process the data for the user; and
in response to the corresponding computing device storing data the user:
deducting a portion of the storage credits from the user;
assigning the portion of the storage credits to the other user associated with the corresponding computing device; and
enabling the corresponding computing device to store the data for the user.
